(19) United States
(12) Patent Application Publication
(10) Pub. No.: US 2016/0216562 A1
(43) Pub. Date: Jul. 28, 2016

(54) LIQUID CRYSTAL DISPLAY DEVICE

(71) Applicant: Samsung Display Co., Ltd., Yongin-Si (KR)

(72) Inventors: Sung Hee HONG, Hwaseong-si (KR); Un Byoll KO, Yeoju-si (KR); Jang-Il KIM, Asan-si (KR)

(21) Appl. No.: 14/967,078

(22) Filed: Dec. 11, 2015

(30) Foreign Application Priority Data
Jan. 22, 2015 (KR) 10-2015-0010585

(51) Int. Cl. G02F 1/1337; G02F 1/1368; G02F 1/1343

(52) U.S. Cl. CPC G02F 1/133707; G02F 1/134336; G02F 1/1368

(57) ABSTRACT

A curved display device may include a pixel electrode, a common electrode, and a liquid crystal layer positioned between the pixel electrode and the common electrode. The pixel electrode may be longer in a first direction than in a second direction in a plan view associated with the curved display device. The second direction may be perpendicular to the first direction. The common electrode may have a slit and a conductive portion. The slit may be longer in the first direction than in the second direction in the plan view and may abut the conductive portion. The conductive portion may be longer than an end-to-end (and/or edge-to-edge) length of the slit in the first direction in the plan view and may have no opening that extends in the second direction in the plan view.

### CROSS-REFERENCE TO RELATED APPLICATION

This application claims priority to and the benefit of Korean Patent Application No. 10-2015-0010585 filed in the Korean Intellectual Property Office on Jan. 22, 2015; the entire contents of the Korean Patent Application are incorporated herein by reference.

### BACKGROUND

(a) Field

The technical field is related to a liquid crystal display device.

(b) Description of Related Art

A liquid crystal display device may include two panels with field generating electrodes, such as a pixel electrode and a common electrode, and may include a liquid crystal layer interposed between the two panels. The liquid crystal display device may apply a voltage to the field generating electrode to apply an electric field to the liquid crystal layer. The electric field may determine orientations of liquid crystal molecules in the liquid crystal layer. Therefore, light transmitted through the liquid crystal layer may be controlled, such that an image may be displayed.

The above information disclosed in this Background section is for enhancement of understanding of the background related to the invention. The Background section may contain information that does not form the prior art that is already known in this country to a person of ordinary skill in the art.

### SUMMARY

Some features may be described based on a plan view associated with a described device without explicitly referring to the plan view.

An embodiment may be related to a curve display device. The curved display device may include a first pixel electrode, a common electrode, and a liquid crystal layer positioned between the first pixel electrode and the common electrode. The first pixel electrode may be longer in a first direction than in a second direction in a plan view associated with the curved display device. The second direction may be perpendicular to the first direction. The common electrode may have a first slit and a first conductive portion. The first slit may be longer in the first direction than in the second direction in the plan view and may abut the first conductive portion. The first conductive portion may be longer than an end-to-end (and/or edge-to-edge) length of the first slit in the first direction in the plan view and may have no opening that extends in the second direction in the plan view.

In the plan view, the first conductive potion may extend from a first edge of the common electrode to a second edge of the common electrode in the first direction with a constant width in the second direction.

A minimum width of the first conductive portion in the second direction may be greater than or equal to three times a maximum width of the first slit in the second direction.

The common electrode may have a second conductive portion. The second conductive portion and the first conductive portion may respectively abut opposite edges of the first slit. The second conductive portion may be longer than the end-to-end length of the first slit in the first direction in the plan view and may not have any opening that extends in the second direction in the plan view.

The common electrode may have a plurality of notches. The notches may extend from the first slit in the second direction. Each of the notches may have a triangular shape in the plan view. A maximum length of each of the notches in the second direction may be less than or equal to three times a minimum width of the first slit in the second direction in the plan view.

The curved display device may include a second pixel electrode, which may immediately neighbor the first pixel electrode and may be aligned with the first pixel electrode in the second direction in the plan view. The common electrode may have a second slit. The second slit may be longer in the first direction than in the second direction in the plan view. The first slit may be positioned on the first pixel electrode. The second slit may be positioned on the second pixel electrode. In the plan view, a minimum distance between the first slit and the second slit in the second direction may be greater than or equal to three times a maximum width of the first slit in the second direction.

The curved display device may include a third pixel electrode, which may immediately neighbor the second pixel electrode and may be aligned with the second pixel electrode in the second direction in the plan view. The first pixel electrode, the second pixel electrode, and the third pixel electrode may belong to a same pixel of the curved display device. The common electrode may have a third slit. The third slit may be longer in the first direction than in the second direction in the plan view. The third slit may be positioned on the third pixel electrode. In the plan view, a minimum distance between the third slit and the second slit in the second direction may be greater than or equal to three times a maximum width of the second slit in the second direction.

The first slit may be longer than the first pixel electrode in the first direction in the plan view.

An embodiment may be related to a curve display device. The curved display device may include a first pixel electrode, a common electrode, and a liquid crystal layer positioned between the first pixel electrode and the common electrode. The first pixel electrode may be longer in a first direction than in a second direction in a plan view associated with the curved display device. The second direction may be perpendicular to the first direction. The common electrode may have a first slit. The first slit may be longer than the first pixel electrode in the first direction in the plan view.

The first slit may be positioned on the first pixel electrode. A first portion of the first slit may extend beyond a first edge of the first pixel electrode in the plan view.

The curved display device may include a first transistor, which may be electrically connected to the first pixel electrode. The first portion of the first slit may be positioned on a portion of the first transistor.

The first portion of the first slit may be positioned on a drain electrode of the first transistor.

The first transistor may be electrically connected to first pixel electrode through a contact hole. The first portion of the first slit may be positioned on the contact hole.

A connection part of the first pixel electrode protrudes from the first edge of the first pixel electrode. A drain electrode of the first transistor directly contacts the connection part of the first pixel electrode. The first portion of the first slit may be positioned on the connection part of the first pixel electrode.

A second portion of the first slit may extend beyond a second edge of the first pixel electrode in the plan view.

The second portion of the first slit may be longer than or shorter than the first portion of the first slit.

The curve display device may include a second pixel electrode, which may immediately neighbor the first pixel electrode and may be aligned with the first pixel electrode in the first direction in the plan view. A first portion of the first slit may be positioned on the first pixel electrode. A second portion of the first slit may be positioned on the second pixel electrode. The curved display device may include a transistor. A portion of the transistor may be positioned between the first pixel electrode and the second pixel electrode in the plan view. A third portion of the first slit may be positioned on the portion of the transistor.

An embodiment may be related to a curved liquid crystal display, which may include the following elements: a lower panel on which a pixel electrode including at least one pixel unit electrode (or sub-pixel electrode) is positioned; an upper panel on which a common electrode including at least one common unit electrode is positioned; and a liquid crystal layer positioned between the lower panel and the upper panel, in which the pixel unit electrode is an integrated plate shape which is formed long in a horizontal direction and the common unit electrode includes openings in a horizontal direction.

The pixel electrode may include a high gray pixel electrode and a low gray pixel electrode and the high gray pixel electrode and the low gray pixel electrode may each include one pixel unit electrode.

The openings in the horizontal direction of the common electrode may be each formed in a center of the high gray pixel electrode and a center of the low gray pixel electrode.

The high gray pixel electrode and the low gray pixel electrode may have a horizontally long rectangular shape.

An area occupied by the low gray pixel electrode may be larger than that occupied by the high gray pixel electrode.

The openings of the common electrode may be formed in the same direction as a direction in which the curved liquid crystal display is bent.

The openings of the common electrode may be extendedly formed to adjacent pixels in a horizontal direction.

An area of some of the openings of the common electrode may be formed with a notch.

The notch may be vertically formed to a direction in which the openings of the common electrode are formed.

The same number of notches may be formed in each pixel unit electrode.

The pixel electrode may include a high gray pixel electrode and a low gray pixel electrode and six notches may be formed in a high gray pixel electrode forming area and a low gray pixel electrode forming area, respectively.

The high gray pixel electrode and the low gray pixel electrode may be each applied with different voltages.

The pixel electrode may include a high gray pixel electrode, a middle gray pixel electrode, and a low gray pixel electrode and the high gray pixel electrode, the middle gray pixel electrode, and the low gray pixel electrode may each include one pixel unit electrode.

The openings in the horizontal direction of the common electrode may be each formed in the center of the high gray pixel electrode, the center of the middle gray pixel electrode, and the center of the low gray pixel electrode, respectively.

The openings of the common electrode may be formed in the same direction as a direction in which the curved liquid crystal display is bent.

According to embodiments, in a liquid crystal display device, even if there is horizontal misalignment between a common electrode and pixel electrodes, alignment directions of liquid crystal molecules may remain substantially consistent (e.g., remain two intended alignment directions). Therefore, even if the misalignment occurs due to bending performed in the process of manufacturing the liquid crystal display device, unwanted texture may not significantly occur in images displayed by the liquid crystal display device. Advantageously, satisfactory and/or consistent image quality may be attained.

### BRIEF DESCRIPTION OF THE DRAWINGS

FIG. 1 is a schematic diagram illustrating elements and/or structures related to a pixel of a liquid crystal display device (or liquid crystal display for conciseness) according to an embodiment.

FIG. 2 is a schematic plan view illustrating elements and/or structures related to a pixel of a liquid crystal display according to an embodiment.

FIG. 3 is a schematic plan view illustrating some pixel electrodes of a liquid crystal display according to an embodiment.

FIG. 4 is a schematic plan view illustrating a common electrode of a liquid crystal display according to an embodiment.

FIG. 5 is a schematic plan view illustrating elements and/or structures related to a pixel of a liquid crystal display according to an embodiment.

FIG. 6 is a schematic plan view illustrating elements and/or structures related to a pixel of a liquid crystal display according to an embodiment.

FIG. 7 is a schematic plan view illustrating elements and/or structure in a display device according to an embodiment.

FIG. 8 is a schematic plan view illustrating elements and/or structure in a display device according to an embodiment.

FIG. 9 is a schematic diagram illustrating orientations of liquid crystal molecules in a liquid crystal display according to an embodiment.

FIG. 10 is a schematic diagram illustrating elements and/or structures related to a pixel of a liquid crystal display according to an embodiment.

### DETAILED DESCRIPTION OF EMBODIMENTS

Some embodiments are described with reference to the accompanying drawings. As those skilled in the art would realize, the described embodiments may be modified in various ways.

Although the terms “first”, “second”, etc. may be used herein to describe various elements, these elements should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent, for example, “first-category (or first-set)”, “second-category (or second-set)”, etc., respectively.

In the drawings, thicknesses of layers, films, panels, regions, etc., may be exaggerated for clarity. Like reference numerals may designate like elements. When a first element (such as a layer, film, region, or substrate) is referred to as being “on” a second element, the first element can be directly on the second element, or one or more intervening elements may also be present. When a first element is referred to as being “directly on” a second element, there are no intended intervening elements provided between the first element and the second element.

The term “connect” may mean “electrically connect”. The term “insulate” may mean “electrically insulate”.

A drawing and related description may use a standing or hung position (and/or orientation) of a device as an example. The device may have various positions and/or orientations.

A drawing may represent a plan view projected on a plane. Some curved elements and/or some curved structures may appear flat and/or straight in the plan view and may be described according to the plan view.

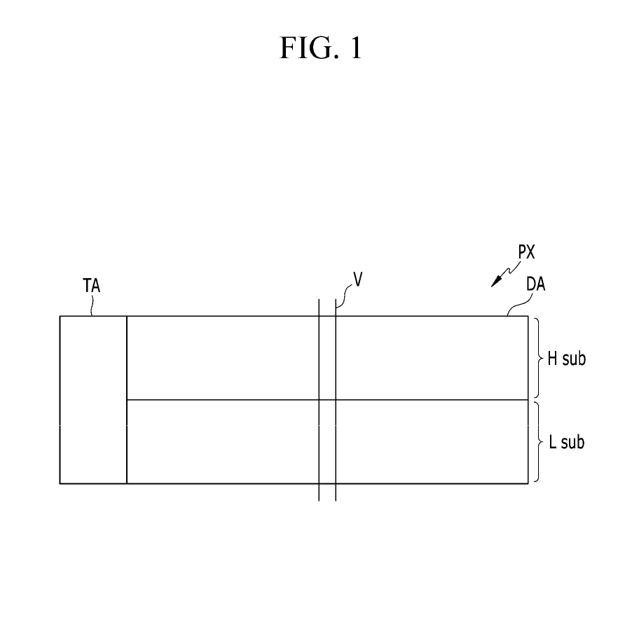

FIG. 1 is a schematic diagram illustrating elements and/or structures related to a pixel PX of a liquid crystal display device (or liquid crystal display or display device for conciseness) according to an embodiment. The schematic diagram may represent a plan view projected on a plane. The liquid crystal display may be a curved liquid crystal display and may include curved elements and/or curved structures.

The pixel PX may be a horizontal pixel that is long in a horizontal direction than in a vertical direction in the plan view. The pixel PX includes a thin film transistor area TA and a display area DA. The display area DA may include field generating electrodes, e.g., pixel electrodes, and liquid crystal molecules. An image (or a portion of an image) may be displayed in the display area DA. The thin film transistor area TA may include one or more thin film transistors and one or more wirings for transferring voltages to the pixel electrodes.

The liquid crystal display may include a reference voltage line V that extends in a vertical direction along a center of the display area DA. The display area DA may include two sub-pixel areas: one high gray sub-pixel area H sub and one low gray sub-pixel area L sub. The high gray sub-pixel area H sub and the low gray sub-pixel area L sub may be aligned in a vertical direction. When the liquid crystal display is in a standing or hung position, the high gray sub-pixel area H sub may be positioned above the low gray sub-pixel area L sub. The reference voltage line V vertically passes through a center of the high gray sub-pixel area H sub and a center of the low gray sub-pixel area L sub in the plan view.

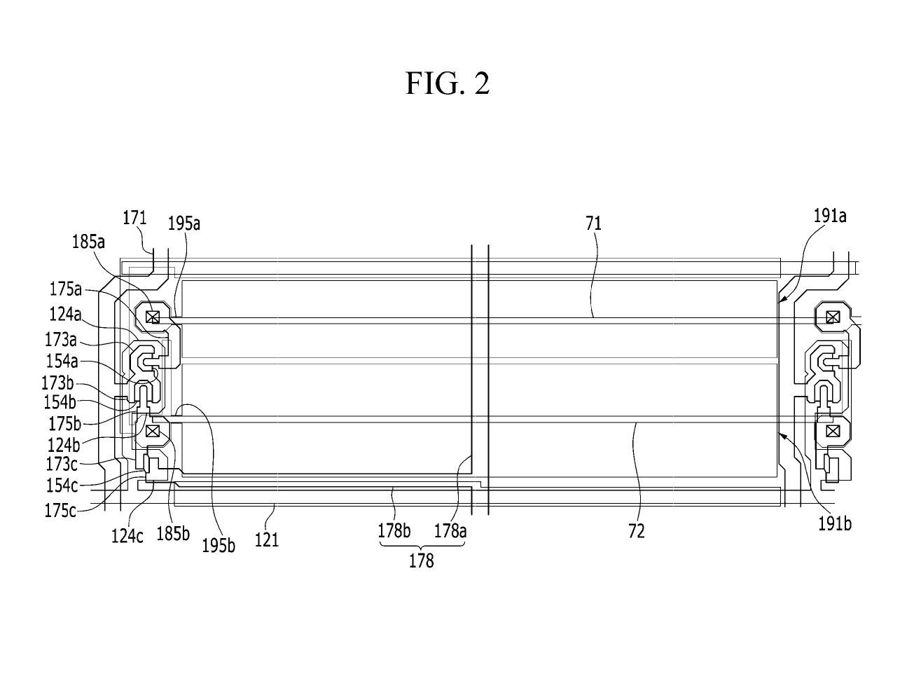

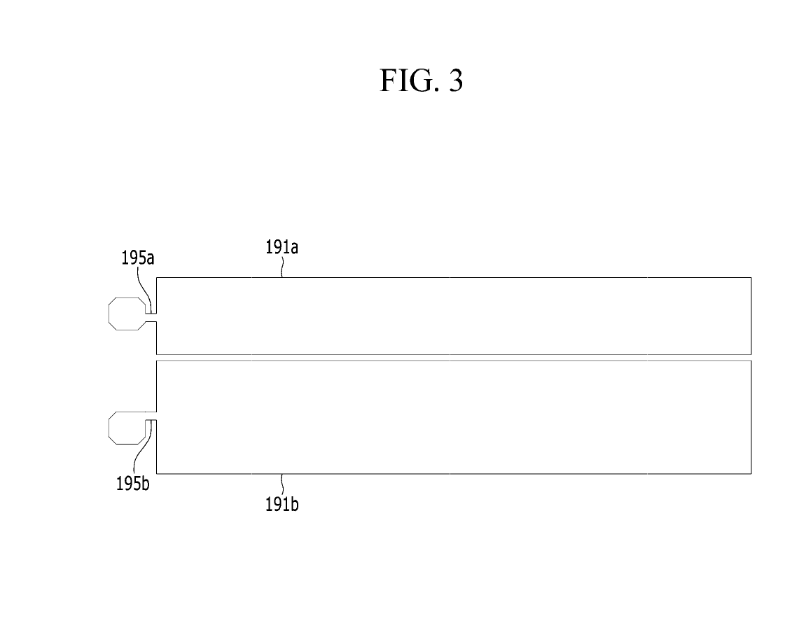

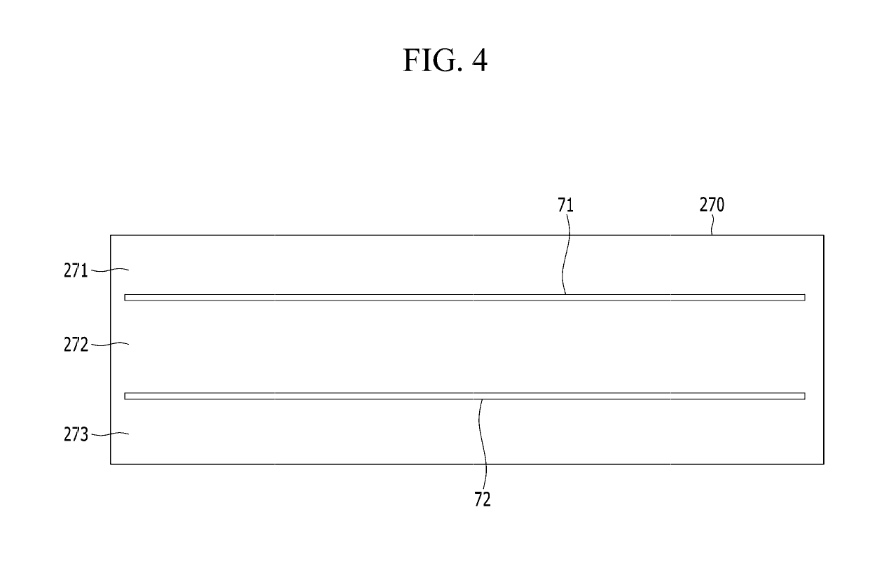

FIG. 2 is a schematic plan view illustrating elements and/or structures related to the pixel PX of the liquid crystal display illustrated in FIG. 1 according to an embodiment. FIG. 3 is a schematic plan view illustrating some pixel electrodes of the liquid crystal display according to an embodiment. FIG. 4 is a schematic plan view illustrating a common electrode of the liquid crystal display according to an embodiment.

The liquid crystal display may include an insulating substrate. The liquid crystal display may include a plurality of gate lines 121, which may be positioned on the insulating substrate.

A gate line 121 may have a curved structure and may extend in a horizontal direction in a plan view of the liquid crystal display. A first gate electrode 124a, a second gate electrode 124b, and a third gate electrode 124c may extend and/or protrude upward from the gate line 121.

The liquid crystal display includes a gate insulating layer, which is positioned on the gate line 121 and the gate electrodes 124a, 124b, and 124c. A first semiconductor 154a, a second semiconductor 154b, and a third semiconductor 154c may respectively overlap the first gate electrode 124a, the second gate electrode 124b, and the third gate electrode 124c and may be positioned on the gate insulating layer.

The liquid crystal display includes data conductors, which include a data line 171, a first source electrode 173a, a first drain electrode 175a, a second source electrode 173b, a second drain electrode 175b, a third source electrode 173c, a third drain electrode 175c, and a reference voltage line 178. The source electrodes and drain electrodes may be positioned on the corresponding ones of the first semiconductor 154a, the second semiconductor 154b, and the third semiconductor 154c and may be positioned on the gate insulating layer.

The data line 171 mainly extends in a vertical direction. The first source electrode 173a and the second source electrode 173b may extend from the data line 171 and may respectively overlap the gate electrodes 124a and 124b.

The reference voltage line 178 may include a main line 178a, which is substantially parallel to the data line 171, and a branch part 178b, which extends from the main line 178a and is substantially parallel to the gate line 121. The branch part 178b extends to the thin film transistor area TA. An end of the branch part 178b forms the third drain electrode 175c.

The first drain electrode 175a faces the first source electrode 173a, the second drain electrode 175b faces the second source electrode 173b, and the third drain electrode 175c faces the third source electrode 173c. The third source electrode 173c is connected to the second drain electrode 175b.

The first gate electrode 124a, the first source electrode 173a, the first drain electrode 175a, and the first semiconductor 154a form a first thin film transistor. The second gate electrode 124b, the second source electrode 173b, the second drain electrode 175b, and the second semiconductor 154b form a second thin film transistor. The third gate electrode 124c, third source electrode 173c, the third drain electrode 175c, and the third semiconductor 154c form a third thin film transistor. The first thin film transistor and the second thin film transistor may receive data voltages through the source electrodes 173a and 173b. The third thin film transistor may receive a reference voltage through the source electrode 173c.

A passivation layer is positioned on the data conductors. Pixel electrodes are positioned on the passivation layer.

The pixel PX includes a high gray pixel electrode 191a, which is positioned in the high gray sub-pixel area H sub, and a low gray pixel electrode 191b, which is positioned in the low gray sub-pixel area L sub.

The high gray pixel electrode 191a and the low gray pixel electrode 191b may extend in a horizontal direction in the plan view. Long edges of the pixel electrodes 191a and 191b may be curved. Short edges of the pixel electrodes 191a and 191b may be substantially straight. A horizontal length of the high gray pixel electrode 191a is substantially equal to a horizontal length of the low gray pixel electrode 191b, but a vertical width of the high gray pixel electrode 191a is narrower than a vertical width of the low gray pixel electrode 191b. An area of the high gray pixel electrode 191a is smaller than an area of the low gray pixel electrode 191b. Referring to FIG. 2 and FIG. 3, each of the high gray pixel electrode 191a and the low gray pixel electrode 191b according to an embodiment may have a continuous plate shape in the plan view and may substantially have no slits or holes.

Referring to FIG. 2, the first drain electrode 175a of the first thin film transistor is connected to a connection part 195a of the high gray pixel electrode 191a through a first contact hole 185a.

The second drain electrode 175b of the second thin film transistor is connected to a connection part 195b of the low gray pixel electrode 191b through a second contact hole 185b.

The third thin film transistor may connect the second drain electrode 175b of the second thin film transistor to the reference voltage line 178 to change a level of the data voltage that is applied to the low gray pixel electrode 191b.

Referring to FIG. 2 and FIG. 4, the liquid crystal display may include a common electrode 270, which may be configured to receive a common voltage. Two long edges of the common electrode 270 may extend in a horizontal direction (or first direction) in a plan view of the liquid crystal display. The long edges of common electrode 270 may be curved. Two short edges of the common electrode 270 may extend in a vertical direction (or second direction) perpendicular to the horizontal direction in the plan view of the liquid crystal display. The short edges of the common electrode 270 may be substantially straight.

The common electrode 270 may have a first opening 71 (or slit 71) and a second opening 72 (or slit 72), which are formed at positions corresponding to a center of the high gray pixel electrode 191a and a center of the low gray pixel electrode 191b, respectively. The first opening 71 may cross the center of the high gray pixel electrode 191a in a horizontal direction in a plan view of the liquid crystal display. The second opening 72 may cross the center of the low gray pixel electrode 191b in a horizontal direction in the plan view of the liquid crystal display. Long edges of the openings 71 and 72 may be curved. Short edges of the openings 71 and 72 may be substantially straight. Each of the openings 71 and 72 may be longer than each of the pixels 191a and 191b in the horizontal direction in the plan view of the liquid crystal display.

The first opening 71 and the second opening 72 are parallel to each other. When the pixel electrodes 191a and 191b and the common electrode 270 are applied with voltages, the openings 71 and 72 of the common electrode 270 may affect alignment directions (and/or orientations) of liquid crystal molecules in the liquid crystal layer of the liquid crystal display.

The common electrode 270 may include a conductive portion 271, a conductive portion 272, and a conductive portion 273. Each of the portions 271, 272, and 273 may be curved. Each of the portions 271, 272, and 273 may extend in the horizontal direction (or first direction) from a first short edge of the common electrode 270 to a second short edge of the common electrode 270.

The opening 71 may be positioned between the portions 271 and 272 and may abut each of the portions 271 and 272. The opening 72 may be positioned between the portions 272 and 273 and may abut each of the portions 272 and 273.

Each the portions 271, 272, and 273 may be longer than each of the openings 71 and 72 in the horizontal direction in the plan view of the liquid crystal display. A minimum width (or minimum dimension) of the portion 271 in the vertical direction (or second direction), a minimum width of the portion 272 in the vertical direction, and/or a minimum width of the portion 273 in the vertical direction may be greater than or equal to three times a maximum width of the opening 71 in the vertical direction and/or may be greater than or equal to three times a maximum width of the opening 72 in the vertical direction.

The minimum width of the portion 272 in the vertical direction may be greater than or equal to each of the minimum width of the portion 271 in the vertical direction and minimum width of the portion 273 in the vertical direction. The minimum width of the portion 272 in the vertical direction may be greater than or equal to three times (e.g., five times) a maximum width of the opening 71 in the vertical direction and/or may be greater than or equal to five times a maximum width of the opening 72 in the vertical direction.

Each the portions 271, 272, and 273 may have a constant width in the vertical direction from the first short edge of the common electrode 270 to the second short edge of the common electrode.

Each of the portions 271, 272, and 273 may have no slits or openings that extend in the vertical direction. Each of the portions 271, 272, and 273 may substantially have no openings.

The high gray pixel electrode 191a and the low gray pixel electrode 191b each may be a sub-pixel electrode. The high gray pixel electrode 191a may be used for controlling alignment directions of corresponding liquid crystal molecules in the high gray sub-pixel area H sub. The low gray pixel electrode 191b may be used for controlling alignment directions of corresponding liquid crystal molecules in the low gray sub-pixel area L sub.

According to an embodiment, the openings corresponding to adjacent pixel electrodes are not connected to each other. That is, the openings 71 and 72 of a pixel are separated from openings 71 and 72 of other pixels. According to an embodiment, openings 71 and 72 may extend over multiple adjacent pixels arranged in a pixel row.

A liquid crystal layer may be interposed between the pixel electrodes and the common electrode and may include liquid crystal molecules, which may have a negative dielectric anisotropy. Major axes of the liquid crystal molecules may be substantially vertical, i.e., substantially perpendicular to the substrate when no electric field is present in the liquid crystal layer.

When the pixel PX is applied with a data voltage, the high gray pixel electrode 191a may receive the data voltage through the first thin film transistor as it is. The low gray pixel electrode 191b may receive the data voltage through the second thin film transistor and may receive an intermediate-level reference voltage through the third thin film transistor. As a result, the voltage level at the high gray pixel electrode 191a may be different from the voltage level at the low gray pixel electrode 191b.

The pixel electrodes 191a and 191b, which are applied with different levels of data voltage, may generate an electric field in the liquid crystal layer along with the common electrode 270 (which may receive a common voltage) to determine orientations of liquid crystal molecules in the liquid crystal layer. In an embodiment, the liquid crystal molecules may be inclined toward the opening 71 and 72 of the common electrode 270.

According to an embodiment, the pixel PX extends in the horizontal direction (according to the plan view of the liquid crystal display), the openings 71 and 72 of the common electrode 270 extend in the horizontal direction, the common electrode 270 may have substantially no slits or openings that extend in the vertical direction, and each of the openings 71 and 72 may be longer than each of the pixels 191a and 191b in the horizontal direction. Therefore, even if curving the liquid crystal display device may cause misalignment between the common electrode 270 and the pixel electrodes 191a and 191b in the horizontal direction, substantially no conspicuous unwanted texture may occur in images displayed by the liquid crystal display device. Advantageously, satisfactory image quality may be attained.

A black matrix may be provided in the thin film transistor area TA. The black matrix may be positioned on the same substrate where pixel electrodes are positioned. In an embodiment, even if misalignment occurs between the common electrode and the pixel electrodes, transmittance reduction potentially caused by misalignment of the black matrix may be prevented. The black matrix may be formed after the pixel electrodes have been formed. The black matrix may function as a column spacer.

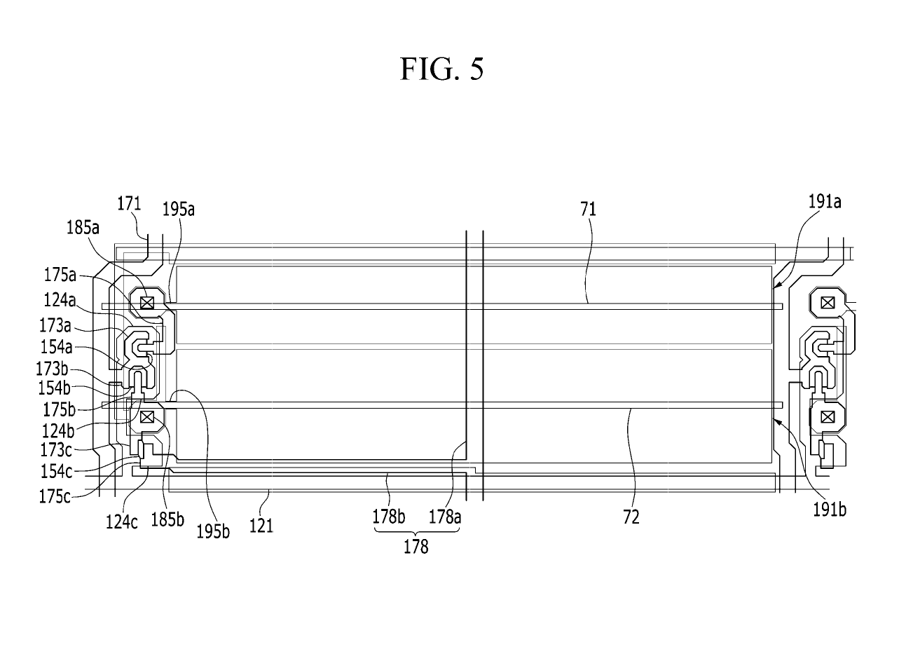

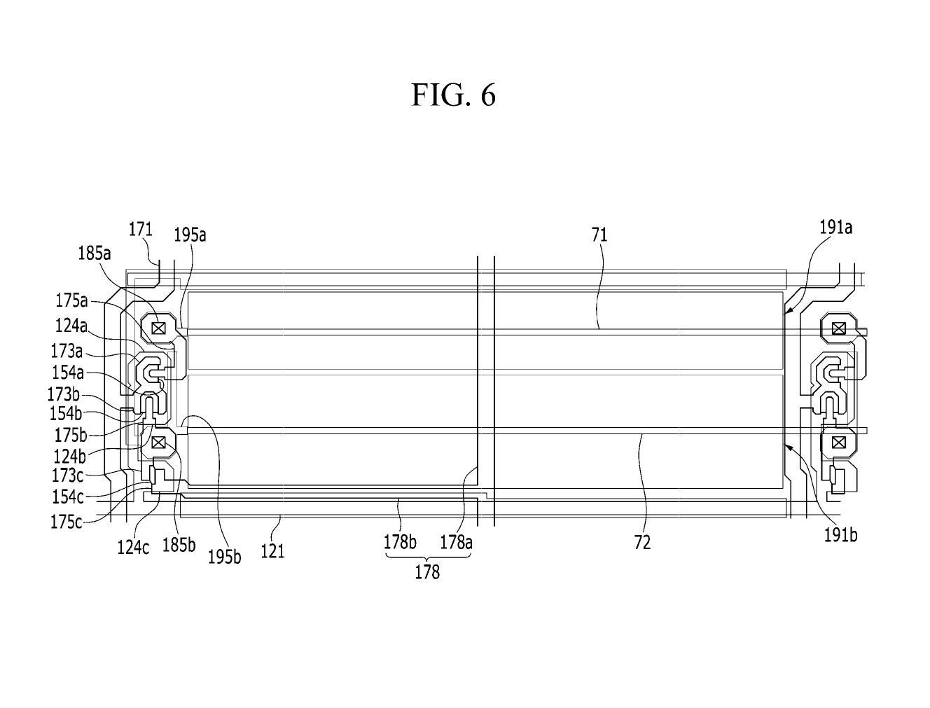

FIG. 5 is a schematic plan view illustrating elements and/or structures related to the pixel PX of the liquid crystal display according to an embodiment. FIG. 6 is a schematic plan view illustrating elements and/or structures related to the pixel of the liquid crystal display according to an embodiment. Referring to FIG. 5, even if the common electrode 270 and the openings 71 and 72 are misaligned to the left, both the openings 71 and 72 may still extend beyond short edges of the pixel electrodes 191a and 191b and may still substantially expose the same center horizontal portions of the pixel electrodes 191a and 191b. Therefore, alignment directions of liquid crystal molecules may remain the same regardless of misalignment or substantial alignment. Advantageously, consistent and/or satisfactory image display quality may be attained.

Referring to FIG. 6, even if the common electrode 270 and the openings 71 and 72 are misaligned to the right, both the openings 71 and 72 may still substantially expose the same center horizontal portions of the pixel electrodes 191a and 191b. Therefore, alignment directions of liquid crystal molecules may remain the same regardless of misalignment or substantial alignment. Advantageously, consistent and/or satisfactory image display quality may be attained.

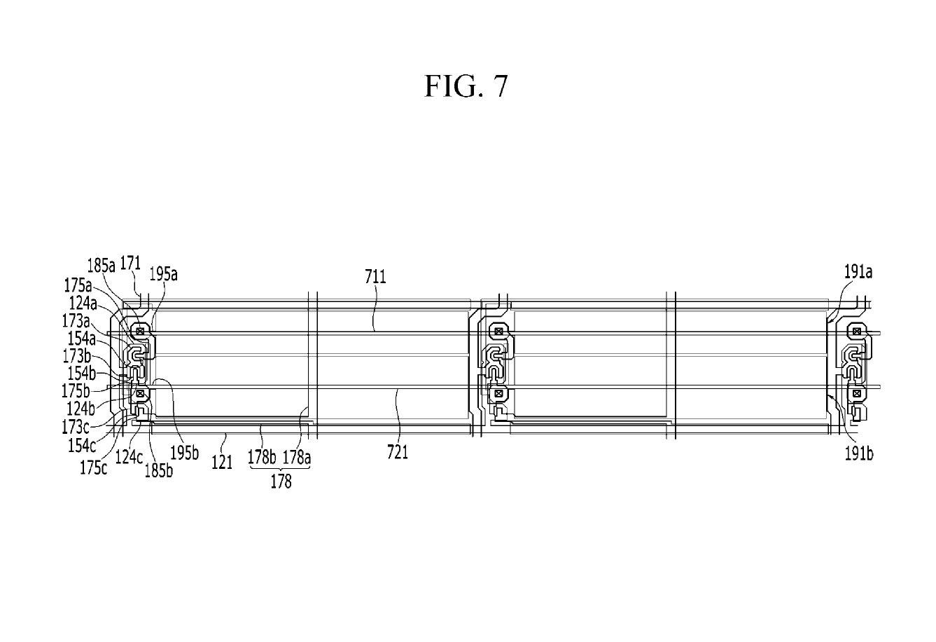

FIG. 7 is a schematic plan view illustrating elements and/or structure in a display device according to an embodiment. Some components of the display device associated with FIG. 7 may be substantially identical to or analogous to some components discussed above with reference to one or more of FIG. 1, FIG. 2, FIG. 3, FIG. 4, FIG. 5, and FIG. 6. Description related to identical components and/or analogous components may not be repeated.

Referring to FIG. 7, in the display device, the openings 711 and 721 of the common electrode may extend over multiple adjacent pixels that are arranged in a pixel row. The openings 711 and 721 and the common electrode may have features that are substantially identical to or analogous to some features of the previously-discussed openings 71 and 72 and common electrode 270.

Each of the openings 711 and 721 may be longer than a combination of the pixel electrodes of the adjacent pixels and the thin film transistor area(s) TA between the pixel electrodes in a horizontal direction in a plan view of the display device. The openings 711 and 721 may cross the thin film transistor area(s) TA without discontinuity. The manufacturing of the common electrode may be substantially simple. Advantageously, manufacturing cost associated with the display device may be minimized. The openings 711 and 721 may enable consistent liquid crystal molecule orientations regardless of misalignment. Advantageously, satisfactory and/or consistent image display quality may be attained.

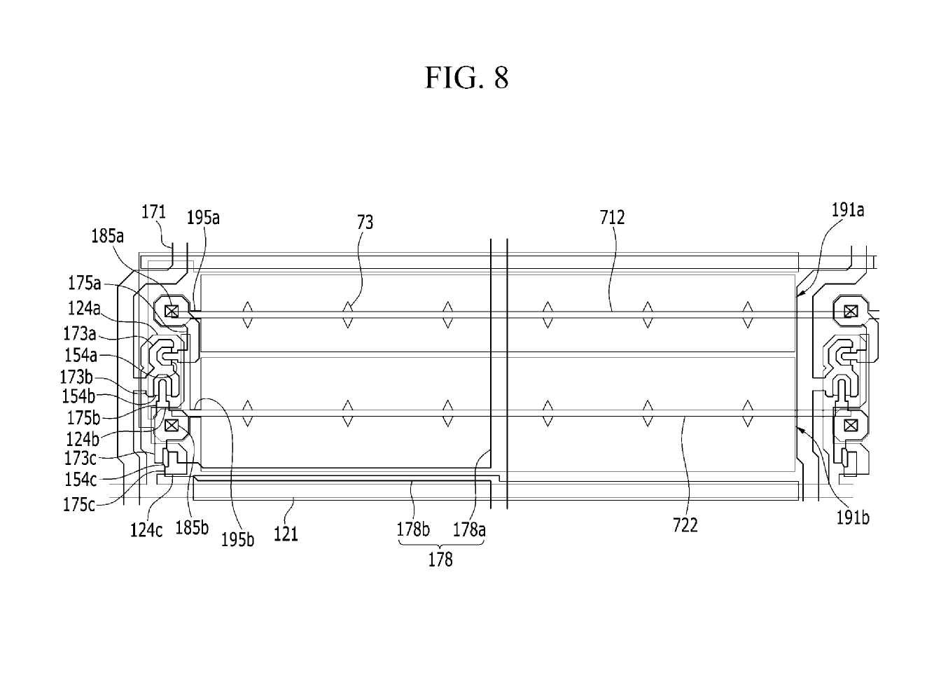

FIG. 8 is a schematic plan view illustrating elements and/or structure in a display device according to an embodiment. Some components of the display device associated with FIG. 8 may be substantially identical to or analogous to some components discussed above with reference to one or more of FIG. 1, FIG. 2, FIG. 3, FIG. 4, FIG. 5, FIG. 6, and FIG. 7. Description elated to identical components and/or analogous components may not be repeated.

Referring to FIG. 8, in the display device, notches 73 may be provided at (and directly connected to) long sides of the openings 712 and 722 of the common electrode. The openings 712 and 722 and the common electrode may have features that are substantially identical to or analogous to some features of the previously-discussed openings 71, 72, 721, and 722 and common electrodes. Each notch 73 may be substantially short in the vertical direction, such that the notches 73 may not cause unwanted conspicuous texture in displayed images even if the common electrode is misaligned with pixel electrodes in the horizontal direction. A maximum length of a notch 73 in the vertical direction may be less than or equal to three times a minimum width of the opening 712 in the vertical direction and/or may be less than or equal to three times a minimum width of the opening 722 in the vertical direction. Like the openings, a notch 73 is an area in which a portion of the common electrode is removed. Each notch 73 may have a triangular shape. Notches 73 may be distributed at a predetermined interval along the horizontal direction.

The display device associated with FIG. 8 may have one or more of the advantages discussed with reference to one or more of FIG. 1, FIG. 2, FIG. 3, FIG. 4, FIG. 5, FIG. 6 and FIG. 7. The notch 73 may enable control of crowding of liquid crystal molecules. Therefore, liquid crystal molecules may not be irregularly crowded in the display device. Advantageously, image quality may be optimized.

In an embodiment, the number of notches 73 corresponding to the high gray sub-pixel area H sub may be equal to the number of notches 73 corresponding to the low gray sub-pixel area L sub. For example, referring to FIG. 8, 6 notches may be formed in each pixel area H sub and L sub, respectively, and thus a total of 12 notches are formed. The number of notches may be configured according to particular embodiments. In an embodiment, the number of notches corresponding to the high gray sub-pixel area H sub may be unequal to the number of notches corresponding to the low gray sub-pixel area L sub.

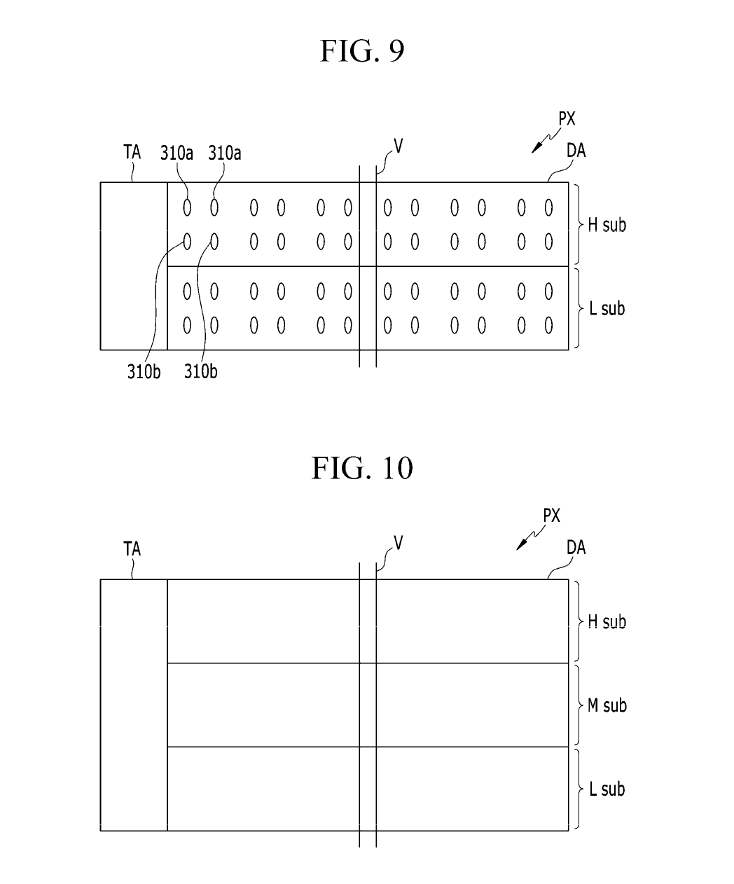

FIG. 9 is a schematic diagram illustrating orientations of liquid crystal molecules in a liquid crystal display according to an embodiment. Referring to FIG. 9, liquid crystal molecules in the liquid crystal display may be aligned in two vertical directions. Liquid crystal molecules 310a may head down toward the center line of the high gray sub-pixel area H sub. Liquid crystal molecules 310b may head up toward the center line of the high gray sub-pixel area H sub. There may be only two alignment directions for the liquid crystal molecules in the high gray sub-pixel area H sub. The alignment directions of liquid crystal molecules adjacent to each other in the horizontal direction may be the same.

Even if there is horizontal misalignment between the common electrode and pixel electrodes, the alignment directions of the liquid crystal molecules may remain the only two directions and may remain unchanged. Therefore, even if the misalignment occurs due to bending of the liquid crystal display, unwanted texture may not occur in display images. Advantageously, satisfactory and/or consistent image quality may be attained.

FIG. 10 is a schematic diagram illustrating elements and/or structures related to a pixel PX of a liquid crystal display according to an embodiment. Some components of the liquid crystal display associated with FIG. 13 may be substantially identical to or analogous to some components discussed above with reference to one or more of FIG. 1, FIG. 2, FIG. 3, FIG. 4, FIG. 5, FIG. 6, FIG. 7, FIG. 8, and FIG. 9. Description related to substantial identical components and/or analogous components may not be repeated.

Referring to FIG. 13, the pixel PX may include a high gray sub-pixel area H sub, a middle gray sub-pixel area M sub, and a low gray sub-pixel area L sub. The middle gray sub-pixel area is positioned between the high gray sub-pixel area and the low gray sub-pixel area. The middle gray sub-pixel area may be applied with a voltage lower than a voltage applied to the high gray sub-pixel area and higher than a voltage applied to the low gray sub-pixel area.

The pixel PX in the liquid crystal display associated with FIG. 13 may have three sub-pixel electrodes. The common electrode of the liquid crystal display may have three horizontal openings respectively positioned at center portions of the high gray sub-pixel area H sub, the middle gray sub-pixel area M sub, and the low gray sub-pixel area L sub. The common electrode and the three horizontal openings may have one or more of the above-discussed features.

While some embodiments have been described as examples, possible embodiments are not limited to the described embodiments. Embodiments are intended to cover various modifications and equivalent arrangements within the spirit and scope defined by the appended claims.

What is claimed is:

1. A curved display device comprising:
a first pixel electrode, which is longer in a first direction than in a second direction in a plan view associated with the curved display device, wherein the second direction is perpendicular to the first direction;
a common electrode, which has a first slit and a first conductive portion, wherein the first slit is longer in the first direction than in the second direction in the plan view and abuts the first conductive portion, and wherein the first conductive portion is longer than an end-to-end length of the first slit in the first direction in the plan view and has no opening that extends in the second direction in the plan view; and
a liquid crystal layer positioned between the first pixel electrode and the common electrode.

2. The curved display device of claim 1, wherein, in the plan view, the first conductive potion extends from a first edge of the common electrode to a second edge of the common electrode in the first direction with a constant width in the second direction.

3. The curved display device of claim 1, wherein a minimum width of the first conductive portion in the second direction is greater than or equal to three times a maximum width of the first slit in the second direction.

4. The curved display device of claim 1, wherein the common electrode has a second conductive portion, wherein the second conductive portion and the first conductive portion respectively abut opposite edges of the first slit, wherein the second conductive portion is longer than the end-to-end length of the first slit in the first direction in the plan view and does not have any opening that extends in the second direction in the plan view.

5. The curved display device of claim 1, wherein the common electrode has a plurality of notches, wherein the notches extend from the first slit in the second direction, and wherein each of the notches has a triangular shape in the plan view.

6. The curved display device of claim 1, wherein the common electrode has a plurality of notches, wherein the notches extend from the first slit in the second direction, and wherein a maximum length of each of the notches in the second direction is less than or equal to three times a minimum width of the first slit in the second direction in the plan view.

7. The curved display device of claim 1, further comprising:
a second pixel electrode, which immediately neighbors the first pixel electrode and is aligned with the first pixel electrode in the second direction in the plan view,
wherein the common electrode has a second slit,
wherein the second slit is longer in the first direction than in the second direction in the plan view,
wherein the first slit is positioned on the first pixel electrode,
wherein the second slit is positioned on the second pixel electrode, and
wherein, in the plan view, a minimum distance between the first slit and the second slit in the second direction is greater than or equal to three times a maximum width of the first slit in the second direction.

8. The curved display device of claim 7, further comprising:
a third pixel electrode, which immediately neighbors the second pixel electrode and is aligned with the second pixel electrode in the second direction in the plan view,
wherein the first pixel electrode, the second pixel electrode, and the third pixel electrode belong to a same pixel of the curved display device,
wherein the common electrode has a third slit,
wherein the third slit is longer in the first direction than in the second direction in the plan view, and
wherein the third slit is positioned on the third pixel electrode.

9. The curved display device of claim 8, wherein, in the plan view, a minimum distance between the third slit and the second slit in the second direction is greater than or equal to three times a maximum width of the second slit in the second direction.

10. The curved display device of claim 1, wherein the first slit is longer than the first pixel electrode in the first direction in the plan view.

11. A curved display device comprising:
a first pixel electrode, which is longer in a first direction than in a second direction in a plan view associated with the curved display device, wherein the second direction is perpendicular to the first direction;
a common electrode, which has a first slit, wherein the first slit is longer than the first pixel electrode in the first direction in the plan view; and
a liquid crystal layer positioned between the first pixel electrode and the common electrode.

12. The curved display device of claim 11, wherein the first slit is positioned on the first pixel electrode, and wherein a first portion of the first slit extends beyond a first edge of the first pixel electrode in the plan view.

13. The curved display device of claim 12, further comprising:
a first transistor, which is electrically connected to the first pixel electrode,
wherein the first portion of the first slit is positioned on a portion of the first transistor.

14. The curved display device of claim 13, wherein the first portion of the first slit is positioned on a drain electrode of the first transistor.

15. The curved display device of claim 13, wherein the first transistor is electrically connected to first pixel electrode through a contact hole, and wherein the first portion of the first slit is positioned on the contact hole.

16. The curved display device of claim 13, wherein a connection part of the first pixel electrode protrudes from the first edge of the first pixel electrode, wherein a drain electrode of the first transistor directly contacts the connection part of the first pixel electrode, wherein the first portion of the first slit is positioned on the connection part of the first pixel electrode.

17. The curved display device of claim 12, wherein a second portion of the first slit extends beyond a second edge of the first pixel electrode in the plan view.

18. The curved display device of claim 17, wherein the second portion of the first slit is longer than the first portion of the first slit.

19. The curve display device of claim 11, further comprising:
a second pixel electrode, which immediately neighbors the first pixel electrode and is aligned with the first pixel electrode in the first direction in the plan view,
wherein a first portion of the first slit is positioned on the first pixel electrode, and
wherein a second portion of the first slit is positioned on the second pixel electrode.

20. The curved display device of claim 19, further comprising:
a transistor, wherein a portion of the transistor is positioned between the first pixel electrode and the second pixel electrode in the plan view, and wherein a third portion of the first slit is positioned on the portion of the transistor.
